(19) United States
(12) Patent Application Publication
(10) Pub. No.: US 2012/0319386 A1
(43) Pub. Date: Dec. 20, 2012

(54) SYSTEM AND METHOD OF INFLATION FOR AN INFLATABLE SEATBELT

(76) Inventors: Wayne Edward Bahr, Livonia, MI (US); Eward Joseph DeSmet, Canton, MI (US); Derek Board, Ferndale, MI (US); Srinivasan Sundarajan, Ann Arbor, MI (US)

(21) Appl. No.: 13/161,229

(22) Filed: Jun. 15, 2011

(51) Int. Cl. B60R 21/18; B60R 21/26

(52) U.S. Cl. 280/733; 280/736

(57) ABSTRACT

An inflatable shoulder belt webbing system and a method for inflating the inflatable shoulder belt webbing system having a buckle, a web loop having a tongue that is selectively engaged by the buckle when the tongue is secured to the buckle and is disengaged when the tongue is removed from the buckle, a lap belt member retained by the web loop, a shoulder belt member having an inflatable webbing portion being contained within the shoulder belt member, the shoulder belt member being retained by the web loop, a tubular member rigidly fixed externally to an outer edge of the web loop and having one end in sealed communication with the inflatable webbing portion, a source of inflation gas, and a manifold rigidly fixed externally to the buckle and having an outlet providing a conduit between the source of inflation gas and the tubular member when the tongue is secured to the buckle.

### TECHNICAL FIELD

The invention is related to an inflatable seat belt and more particularly to a method of inflation for an inflatable seatbelt

### BACKGROUND

Seatbelt systems are available that extend across the lap and torso of a vehicle occupant to hold the occupant within the vehicle during a collision. A shoulder strap across the torso is designed to protect the front torso of the occupant in the event of a collision, but normally do not provide any cushion or shield against an impact. Inflatable seatbelt systems are known which inflate a shoulder strap of the seatbelt system to further protect the occupant by providing cushioned protection. These inflatable seatbelt systems employ different methods for inflating the seatbelt.

One inflation method uses a pyrotechnic inflation system that requires an inflator that is remotely located from the seatbelt system to avoid contact with the inflator because of the temperature associated with the pyrotechnic device. Other inflation systems are known that employ a cold gas. The gas is directed through the buckle and tongue mechanisms into the shoulder strap for inflation. However, these systems typically require complex assembly of a specialized tongue and buckle. This complex configuration presents the disadvantage of high cost for manufacture of parts, assembly and repair. Further, the size of the special anchor and the insertion effort necessary to engage the tongue and the buckle are high, thereby hindering the ease with which the seatbelt may be anchored.

Another disadvantage to inflation that occurs with a charge or directly through the anchor is associated with the force of the gas as it inflates the seatbelt. The rapid inflation at a high force may adversely affect a passenger with soft or brittle bones, such as a child or an elderly person.

There is a need for a system and method for inflating an inflatable seatbelt device using a standard anchor mechanism, thereby easing complexity of assembly, easing complexity of operating, easing the effort required to buckle the belt, and improving the inflation of the seatbelt.

### SUMMARY

An inflatable shoulder belt webbing system and a method for inflating the inflatable shoulder belt webbing system having a buckle, a web loop having a tongue that is selectively engaged by the buckle when the tongue is secured to the buckle and is disengaged when the tongue is removed from the buckle, a lap belt member retained by the web loop, a shoulder belt member having an inflatable webbing portion being contained within the shoulder belt member, the shoulder belt member being retained by the web loop, a tubular member rigidly fixed externally to an outer edge of the web loop and having one end in sealed communication with the inflatable webbing portion, a source of inflation gas, and a manifold rigidly fixed externally to the buckle and having an outlet providing a conduit between the source of inflation gas and the tubular member when the tongue is secured to the buckle.

These and other objects and advantages of the inflatable seat belt system disclosed will be better understood in view of the attached drawings and the following detailed description.

### DESCRIPTION OF DRAWINGS

FIG. 1 is a perspective view of a vehicle seat having an inflatable shoulder belt webbing of the inventive subject matter;

FIG. 2 is a cutaway view of an inflatable shoulder belt of the inventive subject matter;

FIG. 3 is an exploded perspective view of a buckle section of the inflatable shoulder belt webbing of the inventive subject matter; and

FIG. 4 is a cut-away view of the web loop and buckle of the inflatable shoulder belt webbing of the inventive subject matter in a buckled configuration.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DESCRIPTION OF INVENTION

While various aspects of the present invention are described with reference to a particular illustrative embodiment, the invention is not limited to such embodiments, and additional modifications, applications, and embodiments may be implemented without departing from the present invention. In the figures, like reference numbers will be used to illustrate the same components. Those skilled in the art will recognize that the various components set forth herein may be altered without varying from the scope of the inventive subject matter.

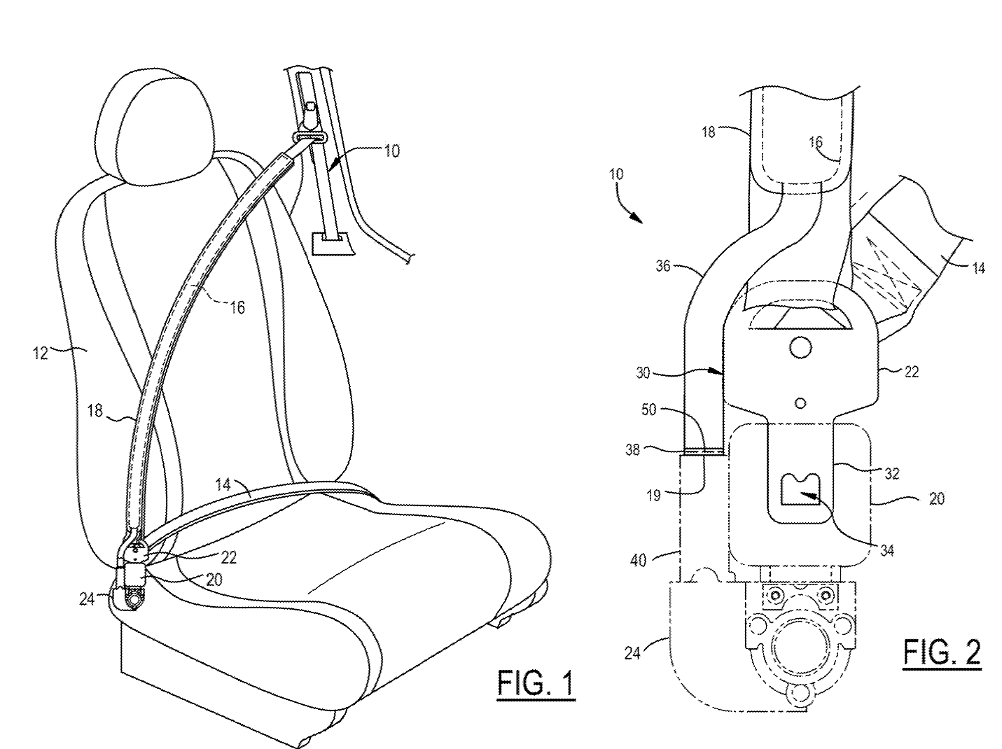

FIG. 1 shows an inflatable shoulder belt webbing 10 in a buckled position extending across a vehicle seat 12. The inflatable shoulder belt webbing 10 has a lap belt section 14 and an inflatable webbing section 16 shown in a non-inflated condition within a shoulder belt section 18. The inflatable webbing section 16 may be received in a hollow, or split, two-layer shoulder belt section 18, which is contiguous with a non-split belt section at either end of the inflatable webbing portion 16. The lap belt section 14 and/or the shoulder belt section 18 are typically attached to retractors (not shown) that retract the seatbelt when the belt is not being used, as is known in the art. A buckle 20 is secured to the seat 12. A web loop 22 retains the lap and shoulder belt sections 14, 18 and engages with the buckle 20. The web loop 22 may slidingly retain the belt sections 14, 18 as for a belt that is a single continuous belt. In the alternative, the belt sections 14, 18 may be fixed to the web loop 22 as separate belt sections. A manifold 24 is likewise rigidly attached externally to the buckle 20 and receives gas from a cold gas inflator through a diffuser (not shown in FIG. 1).

Referring now to FIG. 2, the inflatable shoulder belt webbing 10 is shown in greater detail. The lap belt section 14 and shoulder belt section 18 are attached to the web loop 22. The web loop 22 has a single tongue 32 that is adapted, such as by tongue latch window 34, to be received by the buckle 20 (not shown in FIG. 2) and latched thereto. A tube 36 is rigidly attached to an exterior edge 30 of web loop 22 and has a seal 38 at one end that is also received by the manifold 24, (also not shown in FIG. 2). The other end of the tube 36 is in direct communication with the inflatable webbing portion 16. An inlet 19 allows gas to pass through the tube 36 and into the inflatable webbing portion 16. When a collision is detected, compressed gas flows through the tube 36 by way of the inlet 19 thereby inflating the inflatable webbing portion 16.

The tube 36 is secured to the inflatable webbing portion 16 by any suitable means of attachment. The end of the inlet tube 36 that communicates with the inflatable webbing portion 16 must remain open to allow the compressed gas to travel through the tube 36 and into the inflatable webbing portion 16 of the shoulder belt 18, yet sealed around its outer diameter so as to prevent compressed gas from escaping. The tube 36 is rigidly attached to an exterior edge of the web loop 22. The web loop 22 is a standard web loop configuration with a minimized profile. And a single tongue 32. This ensures that the web loop 22 is easily buckled yet the tube 36 is guided into communication and sealing engagement with the manifold 24. The tube 36 may also have a beveled surface at the seal end to facilitate aligning the tube 36 with the manifold 24.

As discussed above, the web loop 22 is a standard seat belt web loop. The only modification is attachment of the tube 36 to the exterior edge 30 of the web loop 22. This ensures that the manufacture and assembly of the inflatable should belt webbing 10 is minimized, thereby keeping costs down and having minimal effect on the actuation of the seat belt mechanism. Because the web loop itself is unchanged as compared to standard uninflatable seat belt webbing, the force an operator must exert to latch and unlatch the seat belt is unaffected. The configuration of the web loop 22, the size of the tongue 32, the insertion effort, and the release effort of the web loop 22 and the buckle 20 are optimized to reduce the effort and allow for ease of buckling while gaining the added safety measures of the inflatable shoulder belt. Because a standard web loop 22 is available, fewer parts and less complexity are also realized as an advantage to the manufacturer and assembler of the present invention.

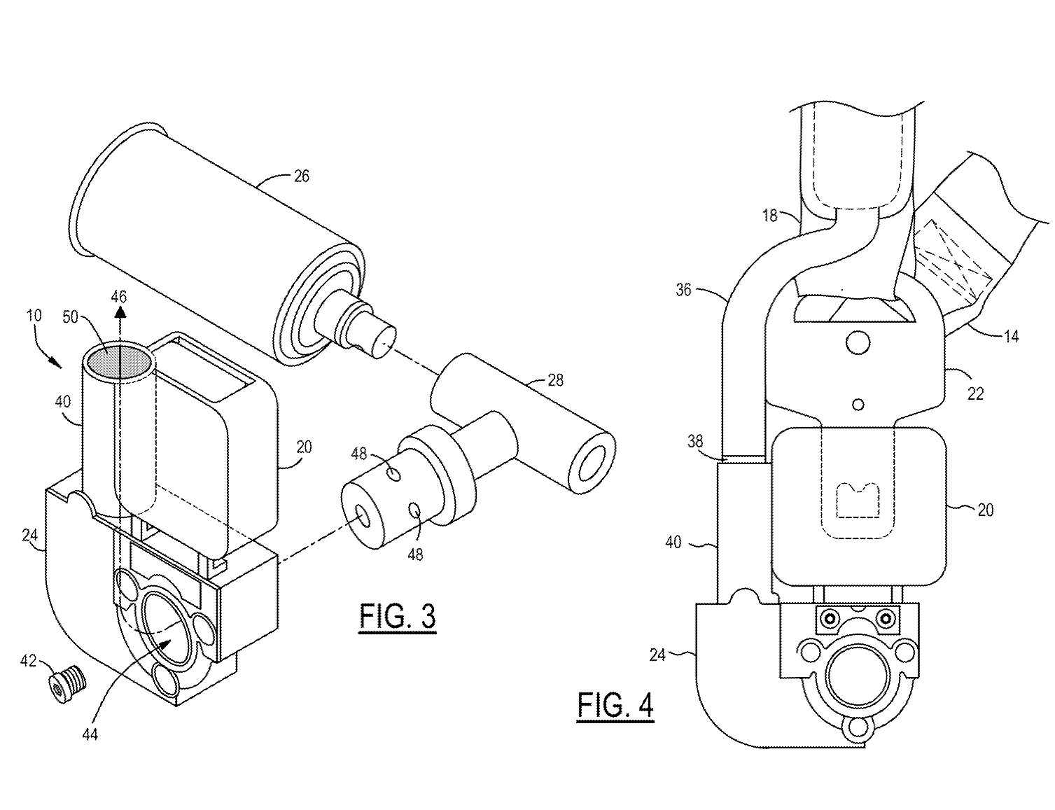

Referring now to FIG. 3, the buckle 20, the manifold 24, the cold gas inflator 26 and a diffuser 28 of the shoulder belt webbing 10 are shown in greater detail in an exploded perspective view. The manifold 24 is rigidly attached to the exterior of the buckle 20. The buckle may be a standard buckle mechanism. A manifold tube 40 extends from the manifold 24 and is also rigidly attached to the exterior of the buckle 20. The manifold tube 40 will communicate with inlet tube 36 (not shown in FIG. 3) when the tongue 32 is inserted into the buckle 20. The cold gas inflator 26 and diffuser 28 are attached to the manifold 24 by a fastener 42 or any other suitable means. The diffuser 28 sealingly engages the manifold 24 so that gas is directed through the manifold 24 and does not escape from the attachment point of the manifold 24 and the diffuser 28.

The manifold 24 has an opening 44 therein for receiving the diffuser 28 and attaching thereto. The manifold 24 and manifold tube 40 define an airway 46 that receives compressed gas through the diffuser 28 from the cold gas inflator 26 and directs the gas to the tube 36. When the tongue 34 of the web loop 22 is inserted into the buckle 20, the tube 36 is aligned in sealed communication with the manifold tube 40. Upon detection of a collision, the cold gas inflator 26 ports compressed gas into the diffuser 28. The diffuser 28 is a receptacle for the compressed gas and has a plurality of gas outlet openings 48 that open into the manifold 28 and dispel gas through the airway 46 and towards the tube 36. Note that the cold gas inflator is shown as being attached to the buckle 20 or mounted to the vehicle seat 12 at the buckle section 20. It should be noted that the cold gas inflator 26 may also be remotely located from the manifold 24 and connected to the manifold 24 or diffuser 28 by a tube or conduit (not shown).

The seal 38 end of the tube 36 and/or the manifold outlet 46 may have a debris screen 50 covering the openings. The debris screen 50, shown on the manifold tube 40, allows the inflator gas to pass through while preventing particulates or other debris from passing through the manifold and/or inflatable webbing section.

Referring to FIG. 4, the buckle 20 and web loop 22 are shown in an assembled configuration. The tongue 32 (not shown) of the web loop 22 is received by the buckle 20. Also for clarity purposes, the mechanism that secures and/or releases the tongue 32 and the buckle 20 is not specifically shown. The seal 38 at the end of the tube 36 creates sealed engagement at the manifold tube 40. The seal 38 prevents liquid and debris from entering the tube 36 and the debris screen 50 (not shown in FIG. 4) ensures unwanted particulates are kept out of the inflatable webbing section 16 (also not shown in FIG. 4). The seal 38 may be mounted at the end of the tube 36, as shown, or it may be placed within the tube 36. It is particularly advantageous that the tube 36 is rigidly fixed to an external edge of the standard web loop 22. The rigid attachment ensures the tube 36 is easily guided to sealed engagement with the manifold tube 40 when the web loop 22 is attached to the buckle 20, but does not require any extra insertion effort on the part of the operator to latch the web loop 22 and buckle 20. The inflatable shoulder belt webbing 10 of the inventive subject matter is just as easily released, by manually depressing a release button (not shown) on the buckle 20 as a standard seat belt configuration. The single tongue 32 is disengaged and the web loop is removed from the buckle 20. At this point, sealed engagement between the seal 38 at the end of tube 36 and the outlet 46 of manifold 24 is released. For similar reasons, it is particularly advantageous that the manifold 24 is rigidly attached to the exterior of the buckle 20.

When the web loop 22 is engaged with the buckle 20 and a collision occurs, inflation gas is ported from the cold gas inflator 26 into the diffuser 28, where it passes through the gas outlet openings 48 and into the manifold 24. The tube 36 receives the gas from the outlet 46 of manifold 24 and directs it to the inflatable belt bag 40. The inflatable belt bag is in communication with the inflatable webbing portion 16, which becomes inflated. The inflation gas is directed to the inflatable webbing section 16 in a path that is completely external to the web loop 22 and buckle 20. The inflation gas bypasses the web loop-buckle assembly completely.

In operation, when a vehicle occupant is seated in the vehicle seat 12, the seat belt harness 10 may be secured by inserting the web loop 22 into the buckle 20. Buckle 20 may be attached to the seat 12 in a pivotal arrangement so that it may be pivoted as necessary by the operator to aid alignment and engagement with the web loop 22. The tube 36 and seal 38 engage the manifold 24 upon attachment of the web loop 22 and the buckle 20. In this engaged position, the lap belt 14 extends across the lap of the occupant and the shoulder belt 18 extends diagonally across the torso of the occupant. In a collision, inputs from crash sensors (not shown), such as accelerometers mounted in various locations throughout the vehicle, may signal a controller to activate the cold gas inflator 26.

When the cold gas inflator 26 is activated, it discharges compressed gas and the gas flows through the diffuser 28, into the manifold 24, through the manifold outlet 46 and into the tube 36. From the tube 36 it passes through the inflatable belt bag section 40 and inflates the inflatable webbing portion 16 of the shoulder belt section 18. As previously described, the manifold 24 and tubes 36 and 40 are external to the web loop 22 and buckle 20. Therefore, the inflation gas bypasses the web loop 22 and buckle 20. The operation of the web loop 22 and buckle 20 are completely independent of the path that the compressed gas follows to inflate the inflatable webbing portion 16.

According to the inventive subject matter, the tube 36 is externally attached to a standard web loop 22 and the manifold 24 is externally attached to a standard buckle 20. Therefore, the method of inflation completely bypasses the buckle 20 and the web loop 22. A significant advantage is that a standard web loop 22 and buckle 20 configuration may be used in production and modified with minimum effort for assembly of these devices as they are known in the art are possible without adding cost and complexity to the inflatable seat belt mechanism, while still realizing the benefits of an inflatable seat belt mechanism. One skilled in the art may appreciate the advantage of being able to use a standard part across many different vehicle lines. The cost savings alone that may be realized is a significant advantage. Other advantages lie in ease of manufacture and ease of assembly and repair. Known inflatable seat belt devices require specialized tongue/buckle configurations that are complex and involve many parts thereby requiring special manufacture and multiple processes for assembly.

The inflatable seat belt device and the method of inflating the seat belt device are significantly simplified by the inventive subject matter. Typically, in known inflatable seat belt configurations, the inflation gas flows through the buckle, tongue and anchor to the inflatable webbing portion. The size and configuration of such a device is bulky and complex. Operation of the buckle typically requires significant extra effort on the part of the operator. With the device and method of the inventive subject matter, the inflation components bypass the buckle, tongue and anchor. Furthermore, the path of the inflation gas is external to these elements. Therefore, operation of the buckle retains normal insertion effort of the tongue 28 of the web loop 22 into the buckle 20, such as would be experienced for a seat belt known in the art that is not of the inflatable design. The standard design may be easily modified according to the inventive subject matter in order to accommodate an inflatable seat belt harness making it accessible to a wide range of vehicle platforms and models. Furthermore, the invention allows for interchangeability of known industry standard buckle and tongue designs which allow greater flexibility in design compatibility, manufacturing and cost competitiveness.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. An inflatable shoulder belt webbing system comprising:
a buckle;
a web loop having a tongue that is selectively engaged by the buckle when the tongue is secured to the buckle and is disengaged when the tongue is removed from the buckle;
a lap belt member retained by the web loop;
a shoulder belt member having an inflatable webbing portion being contained within the shoulder belt member, the shoulder belt member being retained by the web loop;
a tubular member rigidly fixed externally to an outer edge of the web loop and having one end in scaled communication with the inflatable webbing portion;
a source of inflation gas;
a manifold rigidly fixed externally to the buckle and having an outlet providing a conduit between the source of inflation gas and the tabular member when the tongue is secured to the buckle.

2. The system as claimed in claim 1 further comprising a diffuser positioned between the source of inflation gas and the manifold.

3. The system as claimed in claim 1 wherein the buckle is pivotally secured to a vehicle seat.

4. The system as claimed in claim 1 wherein the tubular member further comprises a seal at an end distal to the inflatable belt bag section thereby providing sealed engagement to the manifold outlet when the tongue is secured to the buckle.

5. The system as claimed in claim 4 wherein the tubular member further comprises a beveled end at the seal.

6. The system as claimed in claim 1 further comprising a debris screen disposed between the tubular member and the manifold.

7. The system as claimed in claim 6 further comprising the debris screen is disposed within the manifold outlet.

8. The system as claimed in claim 6 further comprising the debris screen is disposed within the tubular member.

9. The system as claimed in claim 6 further comprising:
a first debris screen disposed within the tubular member; and
a second debris screen disposed within the manifold outlet.

10. The system as claimed in claim 1 wherein the buckle and tongue are modular and interchangeable with standard industry buckle and tongue configurations.

11. The system as claimed in claim 1 wherein the source of inflation gas further comprises a cold gas inflation source.

12. A method for inflating an inflatable seat belt system having a cold gas inflation source and a manifold externally attached to a buckle and providing a conduit to an inflatable seat belt member, the method comprising the steps of:
engaging a web loop of the inflatable seat belt system with the buckle, a tubular member rigidly mounted to an external edge of the web loop, whereby one end of the tubular member is in communication with the inflatable seat belt member and another end of the externally mounted tubular member sealingly engages the manifold;
activating the inflation source to send compressed gas through the manifold and into the tubular member such that the gas inflates the inflatable seat belt member passes through the manifold, through the tubular member and through the inflatable seat belt member, thereby bypassing the buckle and web loop.

13. The method as claimed in claim 12 further comprising the steps of diffusing the compressed gas in the belt bag cold gas inflator member.

14. A system for protecting a vehicle occupant comprising:
a seat belt system having a buckle, a web loop, and an inflatable webbing section;
a manifold rigidly attached externally to an outer edge of the buckle and haying an outlet;
a tubular member rigidly attached externally to an outer edge of the web loop, one end of the tubular member in sealed communication with the inflatable webbing section, and a distal end of the tubular member capable of being in sealed communication with the outlet of the manifold;
an inflation source attached to the manifold; and
a sealed conduit from the inflation source to the inflatable webbing section wherein the outlet of the manifold is sealingly engaged to the distal end of the tubular member externally to and upon engagement of the web loop and buckle.

15. The system as claimed in claim 14 further comprising a diffuser positioned between the source of inflation gas and the manifold.

16. The system as claimed in claim 14 wherein the buckle is pivotally secured to a vehicle seat.

17. The system as claimed in claim 14 further comprising a debris screen disposed between the tubular member and the manifold outlet.

18. The system as claimed in claim 17 further comprising the debris screen is disposed within the manifold outlet.

19. The system as claimed in claim 17 further comprising the debris screen is disposed within the tubular member.

20. The system as claimed in claim 17 further comprising:
to first debris screen disposed within the tubular member; and
a second debris screen disposed within the manifold outlet.

21. The system as claimed in claim 14 wherein the inflation source further comprises a cold gas inflation source.

22. The system as claimed in claim 14 wherein the buckle and tongue are modular and interchangeable with standard industry buckle and tongue configurations.
